(19) United States
(12) Patent Application Publication
(10) Pub. No.: US 2024/0052562 A1
(43) Pub. Date: Feb. 15, 2024

(54) TIE-DYE SYSTEM AND ASSOCIATED METHOD

(71) Applicant: KT Selvedge LLC, DBA Tipsy Tie Dye, Union City, NJ (US)

(72) Inventors: Kevin Tague, Union City, NJ (US); Katherine Tague Hypke, Union City, NJ (US)

(21) Appl. No.: 17/884,958

(22) Filed: Aug. 10, 2022

(51) Int. Cl. D06P 1/00; D06B 11/00; B67D 1/00; B67D 1/04

(52) U.S. Cl. CPC D06P 1/0096; D06P 1/002; D06B 11/0073; B67D 1/0015; B67D 1/04; D06B 2700/04

(57) ABSTRACT

A method including obtaining a first dye powder; mixing the first dye powder with a liquid, to form a first dye mixture; disposing the first dye mixture in a container; pressurizing the first container; opening a first valve in fluid communication with the first container, thereby to dispense the first dye mixture into secondary container; and applying the first dye mixture from the secondary container onto a portion of a fabric article, to form a tie-dye pattern on the fabric article.

### FIELD

The present invention relates to fabrics, and, more particularly, to tie-dyed fabrics.

### BACKGROUND

Tie-dying is a technique in which a user applies a dye, e.g., to a fabric article. For example, a person may apply one or more colored dye mixtures to a fabric article that is an article of clothing, such as a shirt. Before applying the colored dye mixture to the fabric article, however, the person may fold, twist, pleat, or otherwise position at least one portion of the fabric article so that when the person applies the colored dye mixture to a part of the fabric article, the colored dye mixture may not reach some other part of the fabric article. The person may use one or more elastic bands, for example, to secure the fabric article as described above, during and after the application of the colored dye mixture to the fabric article.

Users may tie-dye fabric articles at home. Tie-dyeing fabric articles at home may result in numerous disadvantages, however. For example, users may purchase tie-dye kits, which generally include a number of disposable plastic bottles, each bottle either including a removable cap and a powder that, when the user adds water to the powder, forms a tie-dye mixture, or each bottle including an already-mixed tie-dye mixture. Because tie-dye kits generally require users to remove the caps from the plastic bottles that include the powders, to add water to the powders in the bottles, and to recap the full bottles, users are apt to spill the powders and/or the tie-dye mixtures during the cap removal, as well as during filling or recapping the bottles. Regardless of where users obtain the bottles with the dye-mixtures, however, users are apt to spill the dyes when working in a home setting that is not set-up for tie-dyeing fabrics. Further, users generally do not reuse the bottles, but instead after applying the tie-dye mixture to a fabric article, users usually empty the bottles, during which users again are apt to spill the tie-dye mixtures, and dispose of the bottles, thereby generating waste.

Additionally, the colors formed on fabric articles by consumer-grade tie-dye mixtures, made by mixing consumer-grade powders with water, are generally inferior to corresponding colors formed by commercial-grade dye mixtures that professionals use. For example, the colors formed on fabric articles by the consumer-grade tie-dye mixtures may not be as bright as the colors formed by corresponding commercial-grade dye mixtures. Further, the consumer-grade tie-dye mixtures may not be as colorfast as the corresponding commercial-grade dye mixtures, so that fabric articles dyed with consumer-grade tie-dye mixtures may fade more quickly and to greater extents, when washed, than fabric articles tie-dyed with the commercial-grade dye mixtures.

Accordingly, there exists a need to avoid the above and/or other disadvantages.

### SUMMARY

In an embodiment, a method includes obtaining a first dye powder; mixing the first dye powder with a liquid, to form a first dye mixture; disposing the first dye mixture in a container; pressurizing the first container; opening a first valve in fluid communication with the first container, thereby to dispense the first dye mixture into secondary container; and applying the first dye mixture from the secondary container onto a portion of a fabric article, to form a tie-dye pattern on the fabric article.

In an embodiment, the method includes obtaining a second dye powder; mixing the second dye powder with a liquid, to form a second dye mixture; disposing the second dye mixture in a second container; pressurizing the second container; opening a second valve in fluid communication with the second container, thereby to dispense the second dye mixture into another secondary container; and applying the second mixture from the another secondary container onto the fabric article.

In an embodiment, the first dye mixture has a first color, and the second dye mixture has a second color that is different than the first color.

In an embodiment, the liquid mixed with the first dye powder is water.

In an embodiment, the liquid mixed with the second dye powder is water.

In an embodiment, the first valve comprises a normally-closed valve.

In an embodiment, pressurizing the first container comprises pressurizing the first container with an air compressor.

In an embodiment, pressurizing the first container comprises pressurizing the first container at a low pressure.

In an embodiment, the low pressure comprises a pressure of less than 10 bar.

In an embodiment, the first container comprises a steel keg.

In an embodiment, a system includes a first container containing within an interior thereof a first dye mixture; a second container containing within an interior thereof a second dye mixture; a gas source providing a pressurized gas to the first container and the second container, thereby to pressurize the first dye mixture in the first container and to pressurize the second dye mixture in the second container; a first valve in fluid communication with the first container; and a second valve in fluid communication with the second container.

In an embodiment, the first valve and the second valve comprises normally-closed valves.

In an embodiment, the gas source comprises an air compressor.

In an embodiment, the gas source comprises a low-pressure air compressor.

In an embodiment, the air pressure provided by the air compressor is at a pressure of less than 10 bar.

In an embodiment, the first dye mixture comprises a powder and a liquid.

In an embodiment, the liquid comprises water.

In an embodiment, the system includes a first line connecting the first container to the first valve; a second line connecting the second container to the second valve; and a third line connecting the gas source to at least one of the first container and the second container.

### BRIEF DESCRIPTION OF THE DRAWINGS

For a more complete understanding of the present invention, reference is made to the following detailed description of exemplary embodiments considered in conjunction with the accompanying drawings, which are presented for the purpose of illustration rather than being drawn to scale, and in which:

FIG. 1 is a block diagram illustrating a system.

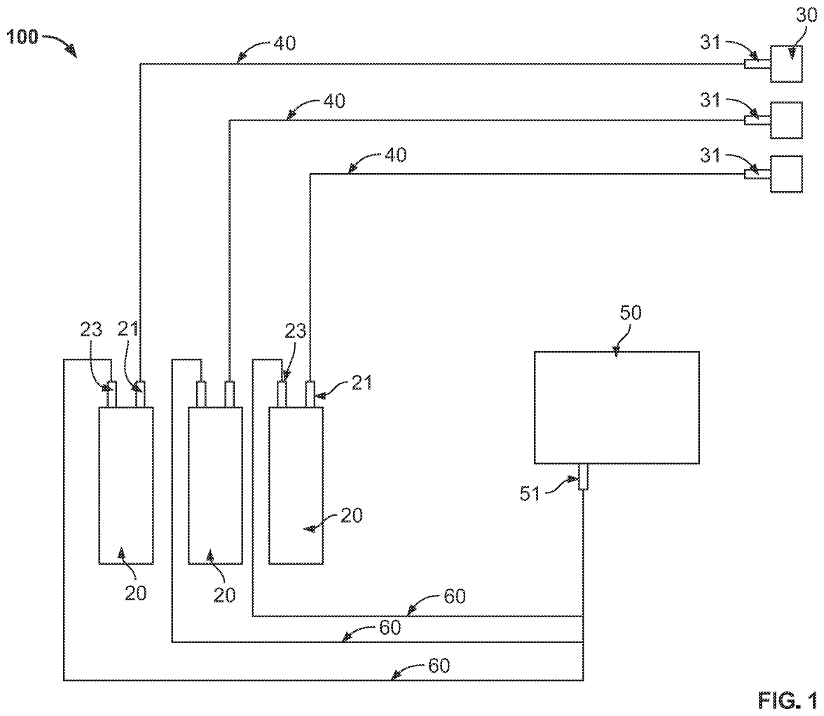

FIG. 2 is an isometric view of a portion of the system.

FIG. 3 is an isometric view of a dispensing counter of the system of FIG. 1.

FIG. 4 is an isometric front view of an interior of the counter.

### DETAILED DESCRIPTION

As shown in the figures, tie-dye system 100 may include at least one liquid storage container 20 connected to at least one valve 30 by at least one liquid line 40. More specifically, as shown in the figure, each container 20 of system 100 may include liquid outlet 21, and each valve 30 may include liquid inlet 31, line 40 connecting outlet 21 to inlet 31.

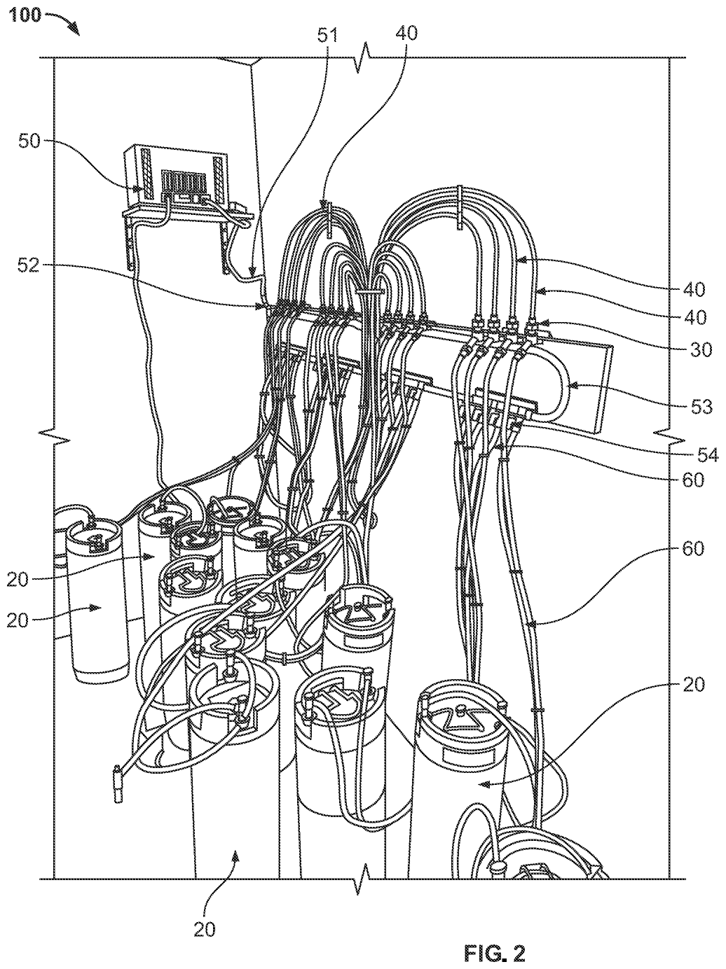

System 100 may include multiple containers 20, valves 30, and/or lines 40. System 100 may include any number of containers 20, including a greater or lesser number of containers 20 than the figures illustrate. In an embodiment, system 100 may include one (1) each of container 20, valve 30, and/or line 40. In an embodiment, system 100 may include more than one of each of container 20, valve 30, and/or line 40. In an embodiment, as shown in FIG. 2, for example, system 100 may include sixteen (16) each of containers 20, valves 30, and lines 40.

System 100 may also include compressed gas source 50 connected to one or more of containers 20 by at least one gas line 60. More specifically, as shown, source 50 may include gas outlet 51, and one or more of containers 20 each may include gas inlet 23, lines 60 connecting outlet 51 to inlets 23. In an embodiment, source 50 may have one outlet 51, and may include additional valves, ports, or other structure to distribute compressed gas output by source 50 to each of containers 20. For example, as shown in FIG. 2, source 50 includes outlet line 51, connecting to valve 52, connecting to gas distribution line 53, connecting to gas lines 60 through additional valves 54. In an embodiment, source 50 may have multiple outlets 51, each of outlets 51 connected to one or more gas lines 60.

By this arrangement, compressed gas from source 50, introduced into one or more of containers 20, may pressurize one or more of containers 20, so that when opening valve 30 in fluid communication with that container 20, liquid stored in container 20 may flow from container 20 to valve 30. More specifically, when open, valve 30 may permit liquid flow through therethrough, and, when closed, valve 30 may prevent liquid flow therethrough.

In an embodiment, one or more of containers 20 may store within an interior thereof a dye mixture suitable for dying a fabric article. In an embodiment, the dye mixture may be a tie-dye mixture for tie-dying a fabric article. The dye mixture may be a commercial-grade dye mixture, customarily used by a professional, which may or may not be purchased by a non-professional. The commercial-grade dye mixture may be a mixture mixed and/or otherwise prepared by a professional dye-mixer who is not the intended user of system 100. Formulation of the commercial-grade dye mixture may occur by the professional dye-mixer mixing a commercial-grade dye powder with a liquid, such as water. The commercial-grade dye powder may be a powder obtained by a professional dye-mixer who is not the user of system 100. The commercial-grade dye powder may be a powder that is not sold or otherwise distributed to a non-professional dye-mixer. In an embodiment, a professional dye-mixer may mix the commercial-grade dye powder with the liquid, such as water, either within or outside of one or more of containers 20. In an embodiment, a professional dye-mixer may fill one or more of containers 20 with the commercial-grade dye mixture.

In an embodiment, the dye mixture may be a consumer-grade tie-dye mixture, customarily used by a non-professional; for example, a typical consumer who does not have any industry experience with the dye industry. The consumer-grade tie-dye mixture may be a mixture that is mixed and/or otherwise prepared by a non-professional. Formulation of the consumer-grade tie-dye mixture may occur by the non-professional mixing a consumer-grade tie-dye powder, available at a retail establishment, with a liquid, such as water. The user may mix the consumer-grade dye powder with the liquid, such as water, either within or outside of one or more of containers 20. The user may fill one or more of containers 20 with the consumer-grade tie-dye mixture.

Within system 100, one or more of containers 20 may store the same color dye mixture as, or a different color dye mixture than, one or more other containers 20. In an embodiment, one or more of containers 20 may include an indication of the color of the dye stored therein. For example, in an embodiment, each container 20 may include signage stating the color of the dye mixture contained in the container, and/or may include a color sample visually indicating the color of the dye mixture contained in the container.

In an embodiment, one or more of containers 20 may be a repurposed-beverage container, such as a container previously and/or customarily used to hold within an interior thereof and to dispense therefrom a beverage, such as a carbonated or nitrogenated liquid; for example, a soda or other soft drink. In an embodiment, the repurposed-beverage container may be a keg. In an embodiment, the keg may be a Cornelius keg. In an embodiment, one or more of containers 20 may be a stainless steel material. In an embodiment, one or more of containers 20 may have a liquid-storing capacity of 5 gallons. In an embodiment, one or more of containers 20 may be a keg that includes a metal lid with a pressure release valve, a clamp closure mechanism, and an O-ring. In an embodiment, a professional dye-mixer may open a keg, mix the commercial-grade dye powder with the liquid, such as water, either within or outside of the keg, fill the keg with the commercial-grade dye mix, and close the keg.

In an embodiment, one or more of valves 30 may be a tap. In an embodiment, the tap may include a rotatable portion to open and close the valve, to thereby permit liquid flow through the valve when open, and to thereby prevent liquid flow through the valve when closed. In an embodiment, the tap may include a translatable portion to open and close the valve, to thereby permit and prevent liquid flow through the valve. In an embodiment, one or more of valves 30 may include an indication of the color of the dye stored in the container that is connected to the valve. For example, each valve 30 and/or corresponding tap handle may include signage stating the color of the dye mixture contained in the container connected to the valve, and/or may include a color sample visually indicating the color of the dye mixture contained in the container connected to the valve. In an embodiment, one or more of valves 30 may be biased to a closed position, which prevents liquid from flowing therethrough unless opened.

In an embodiment, one or more of liquid outlets 21, liquid inlets 31, gas inlet 23, and gas outlets 51 may be a quick-connect fitting. In an embodiment, one or more of liquid outlets 21, liquid inlets 31, gas inlets 23, and gas outlets 51 may be a threaded connection. In an embodiment, one or more of liquid outlets 21, liquid inlets 31, gas inlet 23, and gas outlets 51 may be a soldered connection.

In an embodiment, one or more of liquid lines 40 may be a plastic material. In an embodiment, the plastic material may be vinyl. In an embodiment, the plastic material may be PVC. In an embodiment, the plastic material may be polyethylene. In an embodiment, the plastic material may be HDPE. In an embodiment, the plastic material may be flexible. In an embodiment, the plastic material may be relatively inflexible. In an embodiment, the plastic material may be food-grade. In an embodiment, the plastic material may be non-food grade. In an embodiment, one or more of lines 40 may be a metal material. In an embodiment, the metal material may be copper. In an embodiment, the metal material may be steel. In an embodiment, the metal material may be stainless steel. In an embodiment, the metal material may be carbon steel. In an embodiment, one or more of lines 40 may prevent liquid leakage between one or more of containers 20 and one or more of valves 30.

In an embodiment, one or more of gas lines 60 may be a plastic material. In an embodiment, the plastic material may be vinyl. In an embodiment, the plastic material may be PVC. In an embodiment, the plastic material may be polyethylene. In an embodiment, the plastic material may be HDPE. In an embodiment, the plastic material may be flexible. In an embodiment, the plastic material may be relatively inflexible. In an embodiment, the plastic material may be food-grade. In an embodiment, the plastic material may be non-food grade. In an embodiment, one or more of lines 60 may be a metal material. In an embodiment, the metal material may be copper. In an embodiment, the metal material may be steel. In an embodiment, the metal material may be stainless steel. In an embodiment, the metal material may be carbon steel. In an embodiment, one or more of lines 60 may prevent air leakage between compressor 50 and one or more of containers 20.

In an embodiment, compressed gas source 50 may be a source of compressed air. In an embodiment, source 50 may be a canister of compressed gas. In an embodiment, as shown in FIG. 2, source 50 may be an air compressor. In an embodiment, the air compressor may be electrically operable by alternating current electricity. In an embodiment, the air compressor may be a low-pressure air compressor. In an embodiment, the low-pressure air compressor may output compressed air at a pressure of between 0.5 bar to 0.7 bar, which corresponds to a pressure of 7.3 psi to 10.2 psi. In an embodiment, the low-pressure air compressor may output compressed air at a pressure of less than 10 bar. In an embodiment, the pressure of the air may correspond to a viscosity of the commercial dye mixture stored in one or more of containers 20.

In an embodiment, system 100 may include more than one source 50. In an embodiment, the more than one source 50 may include multiples canisters of compressed gas. In an embodiment, the compressed gas may be one or more of air, nitrogen, carbon dioxide, any other inert gas, and combinations thereof. In an embodiment, the more than one source 50 may include multiple air compressors. In an embodiment, the more than one source 50 may include both at least one canister, and at least one air compressor. In an embodiment, the more than one source 50 may include multiple air compressors and multiple canisters. In an embodiment, system 100 may use low-pressure air, provided by an air compressor, and forego the use of carbon dioxide, nitrogen, or other gas stored in a canister.

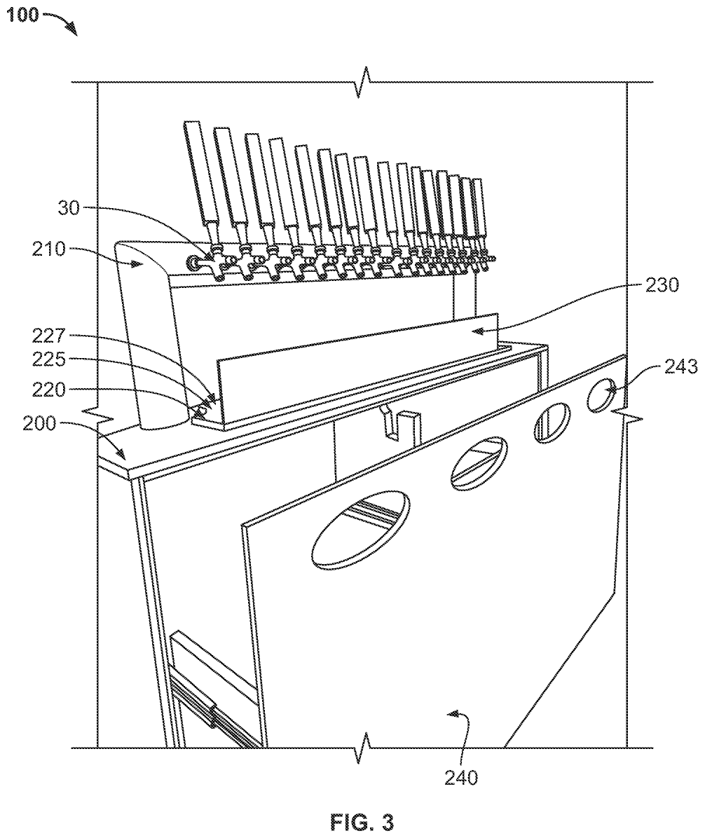

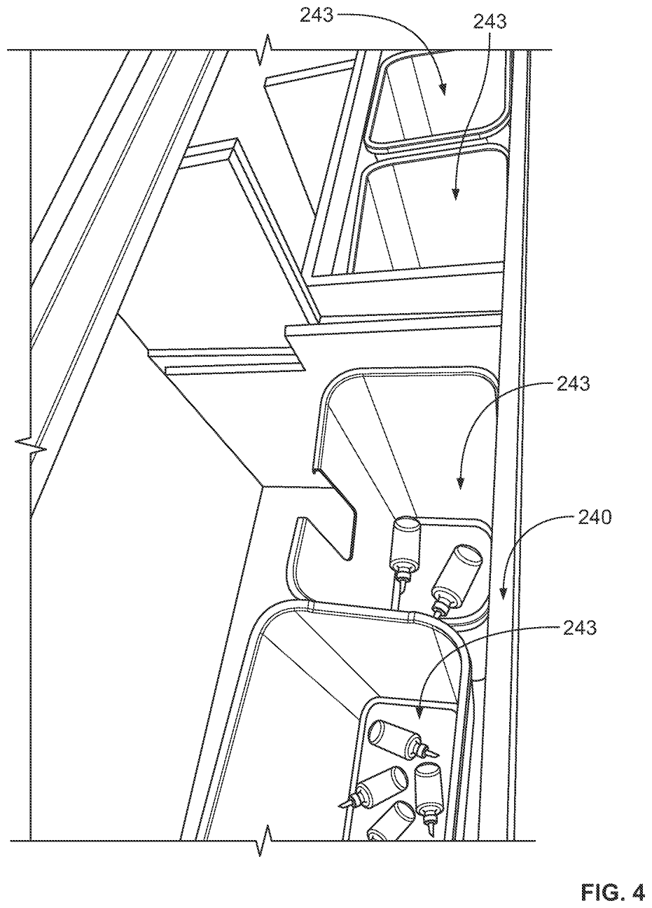

As shown in FIGS. 3 and 4, counter 200 of system may include valve portion 210, retaining one or more of valves 30. Valve portion 210 may retain one or more of valves 30 such that, upon a user opening any particular valve, the dye mixture stored in the corresponding container flows from the interior of the container, through the corresponding liquid line, through the valve, and into a secondary container that the user holds under an opening of the valve. By this arrangement, a user at least partially fills a secondary container with a dye mixture. In an embodiment, the user may place a cap on the filled container.

As shown, counter 200 may include drain portion 220. Drain portion 220 may be arranged to capture any dye mixture that spills, drips, or otherwise escapes from one or more of valves 30 and which does not flow into a secondary container. In an embodiment, drain portion 220 may include a container that retains a quantity of liquid, and requires subsequent emptying. In an embodiment, drain portion 220 may be a bucket, basin, or other container with an open top, and closed sides and bottom. In an embodiment, drain portion 220 may be a container with one or more openings connecting to a drain line, connecting to a wastewater line.

As shown, drain portion 220 may include drain plate 225 including one or more drain holes 227. The one or more drain holes 227 may be sized, shaped, located, and/or arranged such that any commercial-grade dye mixture that spills, drips, or otherwise escapes from one or more of valves 30 and which does not flow into a secondary container is unlikely to contact the user.

As shown, counter 200 may include shield portion 230. Shield portion 230 may be arranged to prevent splashing of any commercial-grade dye mixture that spills, drips, or otherwise escapes from one or more of valves 30 and which does not flow into a secondary container. In an embodiment, shield portion 230 may surround at least a portion of drain portion 220. In an embodiment, shield portion 230 surrounds or at least partially blocks at least one side of drain portion 220.

In an embodiment, a user may use system 100, with or without counter 200, to dispense liquids other than commercial dye mixtures. In an embodiment, a user may use system 100 to dispense an epoxy. In an embodiment, a user may use system 100 to dispense a two-part epoxy. In an embodiment, a user may use one valve 30 to dispense one part of a two-part epoxy, and may use another valve 30 to dispense another part of the two-part epoxy. In an embodiment, one or more of valves 30 may be a mixing valve that mixes two or more liquids flowing through valve 30. In such an embodiment, one valve 30 may be connected to more than one container 20, such as a first container 20 containing in an interior a first part of a two-part epoxy, and a second container 20 containing in an interior a second part of the two-part epoxy, valve 30 mixing the two parts as the epoxy flows through valve 30. In an embodiment, valve 30 may be connected to more than one container, such as more than one container of dye mixture, valve 30 mixing the two colors stored within the containers as the colors flow through valve 30. In an embodiment, one or more of containers 20 may contain therein other liquids, such as but not limited to paint, bleach, varnish, resin, heated water, room temperature water, cooled water, sodium carbonate, oil, sodium metabisulfite, an aqueous chemical mixture, and/or combinations of one or more thereof. In an embodiment, system 100 may be used to deliver one or more other chemicals.

In an embodiment, system 100 may incorporate one or more heaters. In an embodiment, one or more heaters heat the dye mixture or other liquid in one or more of container 20, and/or after flowing from one or more of containers 20. In an embodiment, one or more heaters heat one or more lines 40, through which the dye mixtures flow from the one or more of containers 20 to the one or more of valves 30. In an embodiment, the one or more heaters flow water around the one or more lines 40. In an embodiment, the one or more heaters are coil heaters coiled around the one or more lines 40.

In an embodiment, counter 200 may include front face 240. In an embodiment, front face 240 may include one or more openings 243. In an embodiment, front face 240 may be a portion of a drawer or cabinet, openable to access an interior of counter 200. In an embodiment, one or more of openings 243 may communicate with the interior of counter 200, which defines one or more collection areas 245. In an embodiment, front face 240 may include labels indicating that the one or more collection areas collect one or more specific secondary containers. In an embodiment, one opening 243 may be in communication with a collection area for partially-full secondary containers. In an embodiment, one opening 243 may be in communication with a collection area for used and substantially-empty secondary containers. In an embodiment, one opening 243 may be in communication with a collection area for unused and empty secondary containers. In an embodiment, a person may remove one or more of collection areas 245 from counter 200, to conveniently move secondary containers disposed in one or more collection areas 245. By this arrangement, counter 200 may collect used and/or unused secondary containers, which a person then may wash for subsequent use or reuse. Thus, system 100 results in less waste as compared to consumer-grade tie-dye kits that do not reuse bottles. Further, system 100 provides a setting that facilities tie-dying fabric articles, as compared to a customary setting (such, as, for example, a user's home) in which the user ordinarily tie-dyes fabrics. For example, counter 200 prevents spilling of dye mixtures, and collects spilled dye mixtures.

In an embodiment, any or all of one or more of valves 30, and/or valves incorporated or connected to any inlet, outlet, and/or lines, including but not limited to one or more of outlets 21, one or more of inlets 31, one or more of inlets 23, one or more of outlets 51, one of more of lines 40, and/or one or more of lines 60, may be any type of valve. In an embodiment, any of the valves may be a manually-operated valve or an automatic or automated valve. In an embodiment, any of the valves may be a check valve, a one-way valve, a ball valve, and/or any other type of valve.

In an embodiment, system 100 may include any number and/or type of lines, hoses, valves, connections, and/or other hardware to provide connections between and among container 20, valves 30, and source 50. Further, any of line(s) 40 and/or line(s) 60 may comprises any number of sublines, with or without one or more valves, connecting container 20 to valve 30, and/or connecting source 50 to container 20.

In an embodiment, system 100 may omit counter 200. In an embodiment, system 100 may reside within a building, such as an establishment in which one or more users tie-dye fabric articles. In an embodiment, system 100 may reside within an or all of an automobile, trailer, or other movable setting.

In an embodiment, system 100 may be used to deliver the tie-dye mixture, or another substance, to an article other than a fabric article.

In an embodiment, system 100 may encompass any type of fiber treatment. Thus, the above-discussion of system 100 as a tie-dye system may be a specific implementation of system 100.

It should be understood that the embodiments described herein are merely exemplary in nature and that a person skilled in the art may make many variations and modifications thereto without departing from the scope of the present invention. All such variations and modifications, including those discussed above, are intended to be included within the scope of the embodiments.

1. A method, comprising:
obtaining a first dye powder;
mixing the first dye powder with a liquid, to form a first dye mixture;
disposing the first dye mixture in a first container;
pressurizing the first container including the first dye mixture;
obtaining a second dye powder;
mixing the second dye powder with a liquid, to form a second dye mixture;
disposing the second dye mixture in a second container;
pressurizing the second container including the second dye mixture;
opening a first valve in fluid communication with the first container, thereby to dispense the first dye mixture through a first outlet of a first tap body, into a first external bottle not in fluid communication with the first container or the second container;
opening a second valve in fluid communication with the second container, thereby to dispense the second dye mixture through a second outlet of a second tap body, into a second external bottle not in fluid communication with the first container, the second container, or the first external bottle,
wherein the first tap body is separate from and spaced apart from the second tap body;
applying the first dye mixture from the first external bottle onto a portion of a fabric article, to form a tie-dye pattern on the fabric article; and
applying the second mixture from the second external bottle container onto the fabric article.

2. (canceled)

3. The method according to claim 1, wherein the first dye mixture has a first color, and the second dye mixture has a second color that is different than the first color.

4. The method according to claim 1, wherein the liquid mixed with the first dye powder is water.

5. The method according to claim 4, wherein the liquid mixed with the second dye powder is water.

6. The method of claim 1, wherein the first valve comprises a valve that is biased to a closed position.

7. The method of claim 1, wherein pressurizing the first container comprises pressurizing the first container with an air compressor.

8. (canceled)

9. The method of claim 1, wherein pressurizing the first container comprises pressurizing the first container with an air compressor to a pressure of less than 10 bar.

10. The method of claim 1, wherein the first container comprises a steel keg.

11.-22. (canceled)

23. The method of claim 1, further comprising:
positioning the first external bottle under the first valve, before the opening the first valve.

24. The method of claim 1, further comprising:
collecting the first external bottle, after the applying the first dye mixture.

25. The method of claim 24, further comprising:
washing the first external bottle, after the collecting.

26.-31. (canceled)
